(19) United States
(12) Patent Application Publication
(10) Pub. No.: US 2023/0245047 A1
(43) Pub. Date: Aug. 3, 2023

(54) LOAD BUILDER OPTIMIZER USING A COLUMN GENERATION ENGINE

(71) Applicant: Walmart Apollo, LLC, Bentonville, AR (US)

(72) Inventors: Kunlei Lian, Bentonville, AR (US); Ming Ni, Bentonville, AR (US); Mingang Fu, Palo Alto, CA (US)

(73) Assignee: Walmart Apollo, LLC, Bentonville, AR (US)

(21) Appl. No.: 17/589,030

(22) Filed: Jan. 31, 2022

(51) Int. Cl. G06Q 10/08; G06Q 10/04

(52) U.S. Cl. CPC G06Q 10/08355; G06Q 10/047

(57) ABSTRACT

A system including one or more processors and one or more non-transitory computer-readable media storing computing instructions that, when executed on the one or more processors, cause the one or more processors to perform: receiving multiple purchase orders for delivery of items from vendors to distribution centers of a distribution network over a period of time, wherein each of the multiple purchase orders specifies a respective vendor of the vendors and a respective distribution center of the distribution centers; generating partitions of the distribution network; generating respective candidate load routes for fulfilling the purchase orders for each of the partitions in parallel using a multi-threaded column generation engine; and selecting final load routes from the respective candidate load routes. Other embodiments are disclosed.

### TECHNICAL FIELD

This disclosure relates generally relates to a load builder optimizer using a column generation engine.

### BACKGROUND

A truck can transport loads of items from vendors to distribution centers following multiple stops and paths along the way. Many such transportation routes can be inefficient, which can increase costs.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for building loads using a column generation engine, according to an embodiment;

FIG. 4 illustrates a flow diagram of a method of implementing data flow through a column generation-based load generation engine, according to an embodiment;

FIG. 5 illustrates a Venn diagram of exemplary network partitions;

FIG. 6 illustrates a block diagram of exemplary sets of load routes; and

FIG. 7 illustrates a flow chart for a method, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

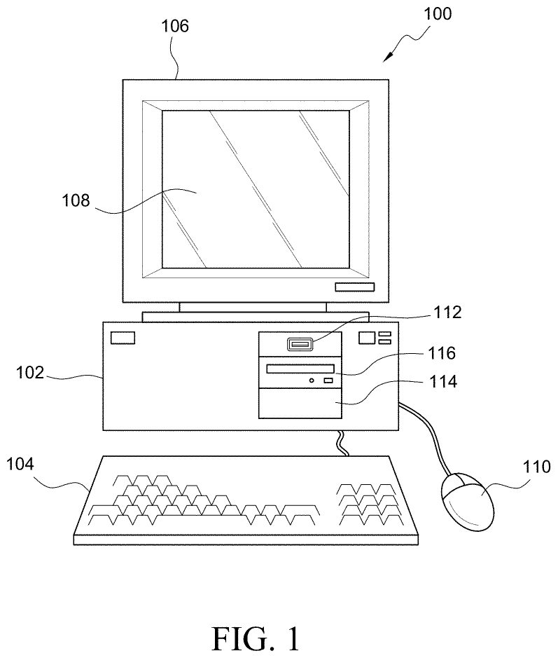

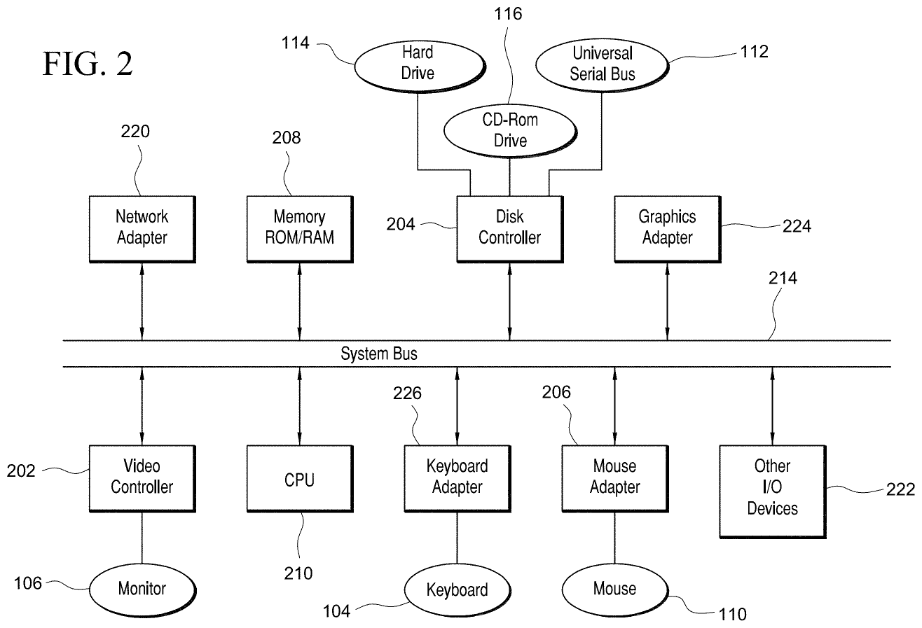

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM).

Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

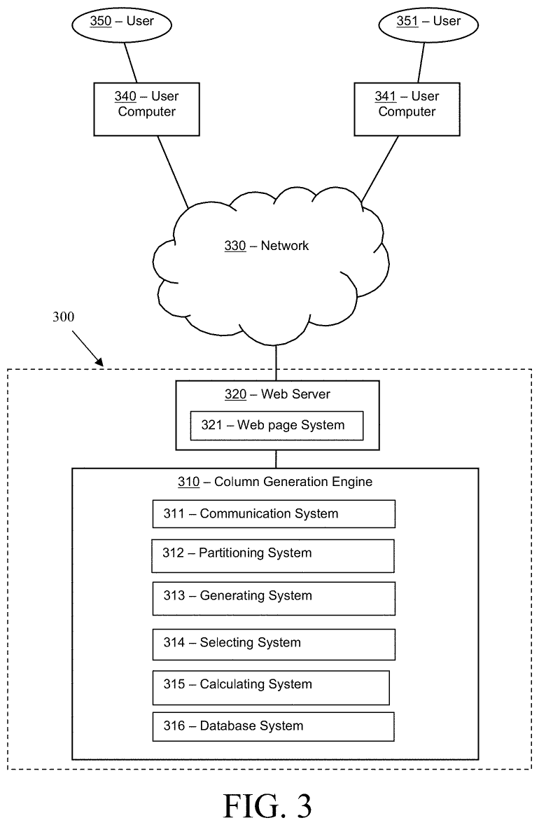

Turning ahead in the drawings, FIG. 3 illustrates a block diagram of a system 300 that can be employed for generating candidate loads for shipping items inbound from vendors to distribution centers, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a column generation engine 310 and/or a web server 320. Column generation engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, column generation engine 310 and/or web server 320. Additional details regarding column generation engine 310 and/or web server 320 are described herein.

In a number of embodiments, each of column generation engine 310 and/or web server 320 can be a special-purpose computer programed specifically to perform specific functions not associated with a general-purpose computer, as described in greater detail below.

In some embodiments, column generation engine 310 and/or web server 320 can be in data communication through network 330 with one or more user computers, such as user computers 340 and/or 341. Network 330 can be a public network (such as the Internet), a private network or a hybrid network. In some embodiments, user computers 340-341 can be used by users, such as users 350 and 351, which also can be referred to as vendors, employees, associates, or customers, in which case, user computers 340 and 341 can be referred to as associate computers. In some embodiments, web server 320 can include a web page system 321. In many embodiments, web server 320 and web page system 321 can host one or more sites (e.g., websites) that allow users to browse and/or search for purchase orders from vendors or sellers, in addition to other suitable activities.

In some embodiments, an internal network that is not open to the public can be used for communications between column generation engine 310, web server 320 and/or web page system 321 within system 300. Accordingly, in some embodiments, column generation engine 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®,

MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can include the Virtual Retinal Display™ product, or similar product by the University of Washington of Seattle, Wash., United States of America. Meanwhile, in further specific examples, a limb mountable wearable user computer device can include the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In several embodiments, column generation engine 310 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to column generation engine 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of column generation engine 310. In a similar manner, the processors and/or the non-transitory computer-readable media can be local and/or remote to each other.

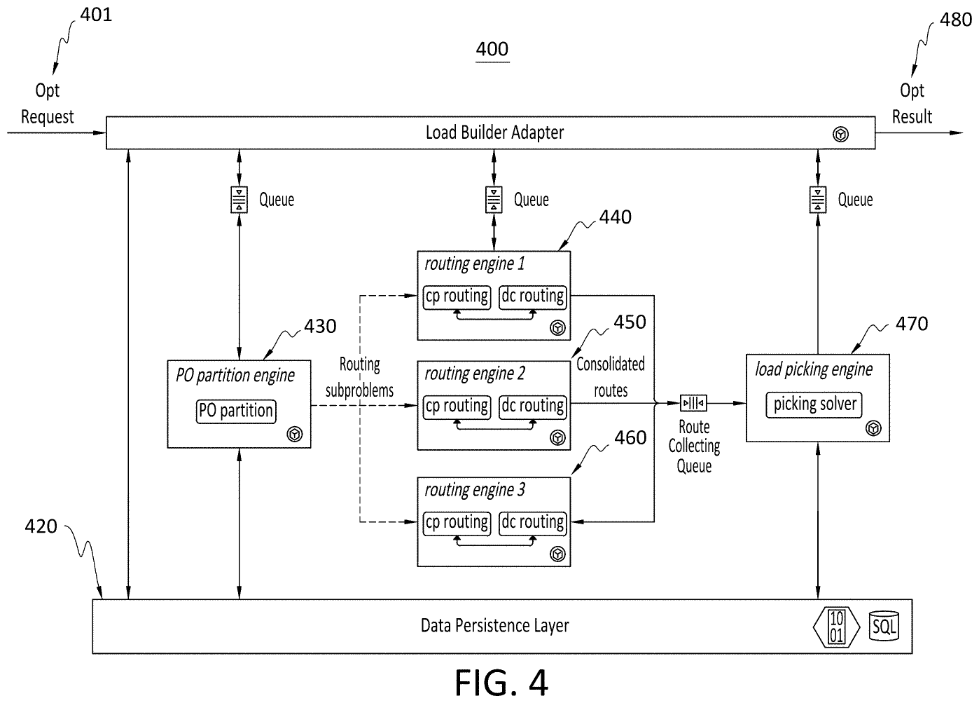

Meanwhile, in many embodiments, system 300 also can be configured to communicate with and/or include one or more databases, such as database system 316. The one or more databases can include a data persistence layer (a block 420 (FIG. 4, described below), among other data, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, column generation engine 310 can include a communication system 311, a partitioning system 312, a generating system 313, a selecting system 314, a calculating system 315, and/or database system 316. In many embodiments, the systems of column generation engine 310 can be modules of computing instructions (e.g., software modules) stored at non-transitory computer readable media that operate on one or more processors. In other embodiments, the systems of column generation engine 310 can be implemented in hardware.

Turning ahead in the drawings, FIG. 4 illustrates a flow diagram for a method 400 of implementing data flow through a column generation-based load generation engine, according to an embodiment. Method 400 can include generating multiple subproblems for a lowest cost metric. Method 400 also can illustrate using multiple parallel routing engines to solve each subproblem. Method 400 further can illustrate consolidating the output received from the multiple routing engines as input for a picking solver (e.g., a load builder optimizer). Method 400 can be used for consolidating loads within an inbound transportation network, wherein the network includes routes to one or more vendors, distribution centers, fulfillment centers, and/or center points. Method 400 can be employed in many different embodiments and/or examples not specifically depicted or described herein. In some embodiments, the procedures, the processes, and/or the activities of method 400 can be performed in the order presented or in parallel. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as column generation engine 310 and/or web server 320. The processor(s) can be similar or identical to the processor(s) described above with respect to computer system 100 (FIG. 1).

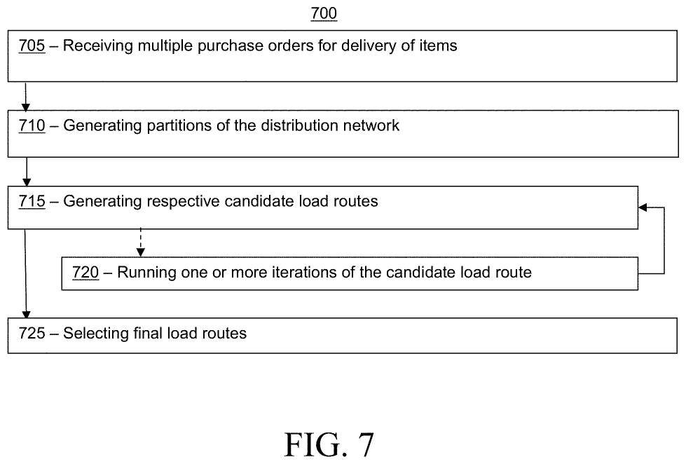

In several embodiments, method 400 can include a block 401 of receiving purchase orders as input data. In some embodiments, a purchase order can specify a freight of goods to be moved from a vendor to a distribution center, a center point location, a fulfillment center and/or another suitable location. In several embodiments, block 401 additionally can store or retrieve a purchase order with a block 420. In various embodiments, method 400 can proceed after block 401 to a block 410. In many embodiments, block 401 can be implemented as described below in connection with block 705 (FIG. 7).

In some embodiments, method 400 can include block 410 of managing an architectural data flow beginning at the input of purchase orders to the output of candidate load routes with a lowest cost metric from other candidate load routes. In several embodiments, block 410 can receive and transmit data interchangeably with block 420, a block 430, a block 440, a block 450, a block 460, a block 470 and/or a block 480. In some embodiments, method 400 can proceed after block 410 to block 420.

In several embodiments, method 400 can include block 420 of storing multiple metrics and/or data points from multiple interactions in a data persistence layer. In some embodiments, block 420 can receive and transmit data interchangeably with block 410, block 430, block 440, block 450, block 460, block 470 and/or block 480. In several embodiments, method 400 can proceed after block 420 to block 430.

In various embodiments, method 400 can include block 430 of dividing, using a purchase order partition engine, the loads into subproblems. In many embodiments, arrival dates also can be included as input data into the purchase order partition engine. In some embodiments, block 430 can retrieve and/or request purchase order data from block 410, as further described above. In many embodiments, block 430 further can route the subproblems to multiple routing engines, as further described below.

In several embodiments, block 430 additionally can store data including purchase orders and subproblems in block 420, as further described below. In various embodiments, method 400 can proceed after block 430 to blocks 440, 450, and/or 460. In many embodiments, block 430 can be implemented as described below in connection with block 710 (FIG. 7).

In a number of embodiments, method 400 can include using multiple routing engines, such as in blocks 440, 450, and 460, which can be run in parallel using a multi-threaded column generation engine. For example, the multiple routing engines can perform block 440 of generating a candidate load route for a subproblem, block 450 of generating another candidate load route for another subproblem, and/or block 460 of generating another candidate load route for another subproblem. In various embodiments, each routing engine (blocks 440, 450, 460) can send a respective candidate load route for each subproblem to a route collecting queue to be consolidated. In several embodiments, blocks 440, 450, and 460 can store candidate load route data on block 420. In some embodiments, method 400 can proceed after blocks 440, 450, and 460 to block 470. In many embodiments, blocks 440, 450, 460 can be implemented as described below in connection with blocks 715 and 720 (FIG. 7).

In several embodiments, method 400 can include block 470 of picking the optimized candidate load route from among the multiple candidate load routes with respective cost metrics. In some embodiments, block 470 further can receive the consolidated candidate load routes as input into a picking solver algorithm. In various embodiments, block 470 also can send the optimized candidate load route to block 480. In several embodiments, block 470 additionally can store candidate load route data on block 420. In some embodiments, method 400 can proceed after block 470 to block 480. In many embodiments, block 470 can be implemented as described below in connection with block 725 (FIG. 7).

In various embodiments, method 400 can include block 480 of outputting an optimized candidate load route. In several embodiments, an output also can include a set of consolidated shipping loads including a sequence of multiple pick up and delivery activities, where each truck load (TL) or less than truck load (LTL) can be based on a threshold fill rate. In some embodiments, a candidate load route can apply to several types of load destinations: (1) a direct vendor to a distribution center (DC); (2) a multi-stop route from multiple vendors to more than one DC; or (3) a multi-stop route from vendors to a center point location. In many embodiments, a center point location can include an interim location between a vendor and DC. In many embodiments, block 480 can be implemented as described below in connection with block 725 (FIG. 7).

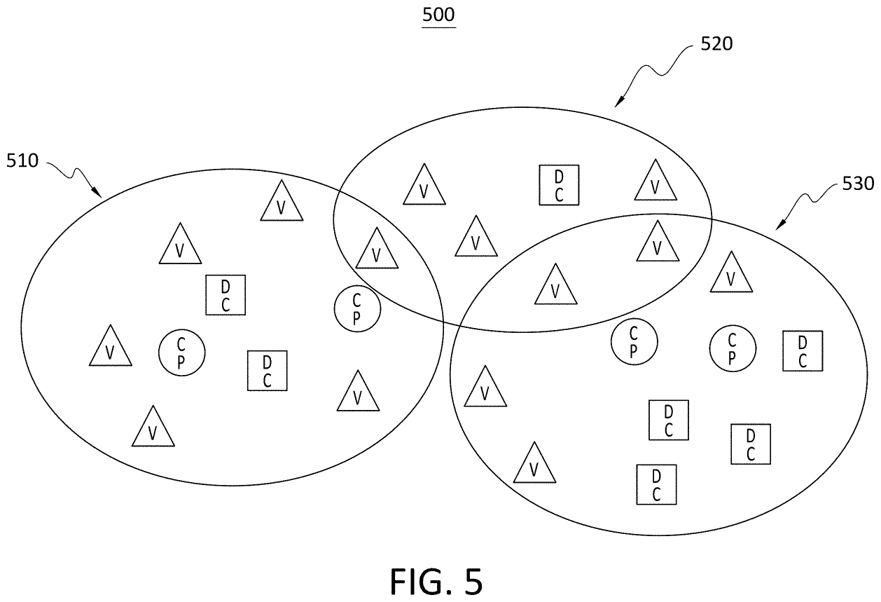

Turning ahead in the drawings, FIG. 5 illustrates a Venn diagram of exemplary network partitions 500, which can generate multiple subproblems of an inbound network division to allow subproblem coverage to overlap, according to an embodiment. In some embodiments, the multiple subproblems can be based on network characteristics or business rules. In several embodiments, network partitions 500 can be represented by a Venn diagram, where each of the 3 circles can overlap with common areas.

In various embodiments, network partitions 500 can include a circle 510, a circle 520, and a circle 530. In some embodiments, each circle (510, 520, and 530) can include a partitioned purchase order analyzed as a subproblem. In several embodiments, each subproblem includes a mix of vendors (V), center points (CP) and DCs based on data from purchase orders, where each purchase order includes an arrival and/or a delivery time schedule. In various embodiments, each subproblem can overlap with another subproblem that can be advantageous as a safeguard to address each load in a purchase order once without missing any loads, comprehensively.

In some embodiments, each partition (e.g., subproblem) of network partitions 500 can include a circle 510 illustrating a subproblem. In several embodiments, deriving a cost metric for delivery in the subproblem of circle 510 includes 6 vendors or vendor stops (V), 2 center points (CP) and 2 distribution centers (DC). Similarly, circle 520 also illustrates a subproblem including 6 V and 1 DC. Similarly, circle 530 illustrates another subproblem including 5 V, 4 CPs and 2 DCs. In network partition 500, circle 520 overlaps with both circle 510 and circle 530 where 1 vendor overlaps between circle 510 and circle 520, and 2 vendors overlap between circles 520 and circle 530. In various embodiments, each subproblem can overlap with another subproblem that can be advantageous as a safeguard to address each load in a purchase order once without missing any loads, comprehensively.

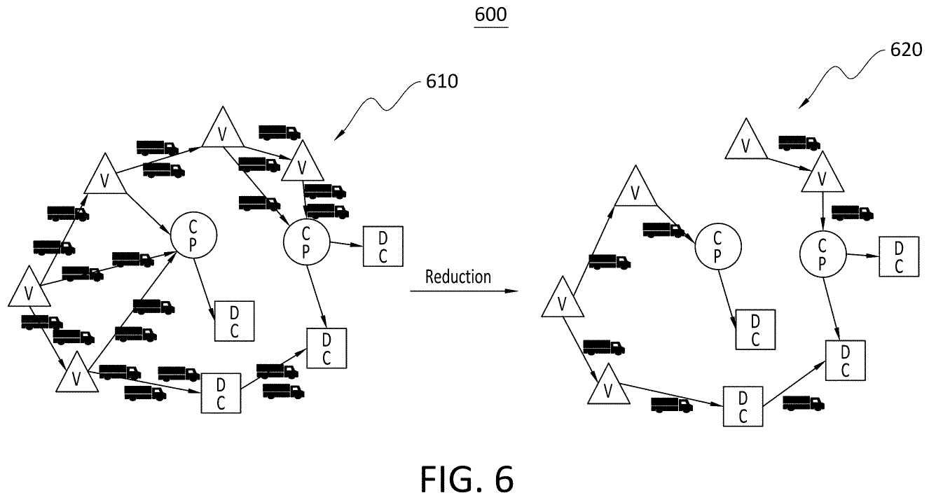

Moving forward in the drawings, FIG. 6 illustrates a block diagram of exemplary sets of load routes 600, showing picking optimal load selections with minimal cost metrics, according to an embodiment. In several embodiments, sets of load routes 600 can include candidate load routes 610, which can show routing candidate loads prior to using the column generation approach, followed by candidate load routes 620 of picking optimal load selections with minimal costs, which is reduced from candidate load route 610.

In some embodiments, candidate load routes 610 can be used for routing candidate loads by (i) generating feasible loads from purchase orders, (ii) determining pickup and delivery times at each location stop, and/or (iii) solving each subproblem using a column generation approach run in parallel (e.g., fast).

In several embodiments, candidate load routes 620 can be used for picking optimal load selections by (i) selecting optimal sets of loads with minimal cost metrics, (ii) using pure binary decision variables, and (iii) reducing a number of candidate route loads per TL or LTL given the same number of stops along the optimized route.

Turning ahead in the drawings, FIG. 7 illustrates a flow chart for a method 700, according to another embodiment. In some embodiments, method 700 can be a method of automatically generating candidate loads for shipping items inbound from vendors to distribution centers. Method 700 is merely exemplary and is not limited to the embodiments presented herein. Method 700 can be employed in many different embodiments and/or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped. In several embodiments, system 300 (FIG. 3) can be suitable to perform method 700 and/or one or more of the activities of method 700.

In these or other embodiments, one or more of the activities of method 700 can be implemented as one or more computing instructions configured to run at one or more processors and configured to be stored at one or more non-transitory computer-readable media. Such non-transitory computer-readable media can be part of a computer system such as column generation engine 310 and/or web server 320. The processor(s) can be similar or identical to the processor(s) described above with respect to computer system 100 (FIG. 1).

Referring to FIG. 7, method 700 can include a block 705 of receiving multiple purchase orders for delivery of items from vendors to distribution centers of a distribution network over a period of time. In several embodiments, each of the multiple purchase orders specifies a respective vendor of the vendors and a respective distribution center of the distribution centers. In various embodiments, multiple purchase orders (e.g., ready purchase orders) can include a freight of goods to be moved from one or more vendor locations to an end destination, such as a DC, CP, or fulfillment center (FP).

In some embodiments, method 700 also can include a block 710 of generating partitions of the distribution network. In several embodiments, partitions of the distribution network can include routing load construction parameters, such as load stops, one-stop pickups, two-stop pickups and/or another suitable parameter. In a number of embodiments, partitions on inbound networks can include changes in network configurations: (i) CP routing can include shipments (e.g., loads) within a same spatial-temporal cluster and/or (ii) DC routing can include shipments with overlapping pickup window time ranges and/or overlapping delivery window time ranges.

In various embodiments, block 710 can include dividing the distribution network into the partitions based on at least one of (i) the distribution centers of the distribution network or (ii) center points of the distribution network. In many embodiments, block 710 can be implemented as described above in connection with FIG. 5.

In a number of embodiments, method 700 additionally can include a block 715 of generating respective candidate load routes for fulfilling the purchase orders for each of the partitions in parallel using a multi-threaded column generation engine.

In various embodiments, a column generation framework (e.g., column generation engine) can include DC or CP routing that refers to the load building process from multiple vendor locations to one or more particular destinations or locations, such as DC or CP. In several embodiments, a CP route can cover multiple DCs, where the purchase orders scheduled for delivery to one or more DCs can be included in the CP routing.

In various embodiments, using column generation framework terminology, a column can refer to a load that includes one or more purchase orders. In some embodiments, the terms column and load can be used interchangeably.

The notation “P” can refer (e.g., denote) to the set of identified purchase orders that route through a CP. In several embodiments, the load building process can be conducted over a span of multiple days, thus “T” can refer to a planning horizon with a unit of a day. In several embodiments, the following variables are defined as follows:

Ω: all the possible columns (loads) for this CP

cⱼ: the transportation cost of the column j∈Ω

eₚⱼ: a binary value indicating whether load j contains the purchase order p∈ [symbol] .

uⱼ: the load quantity of j∈Ω

Uₜ: a capacity value for t∈

[symbol]

In various embodiments, the decision variables are defined as follows below:

xⱼ: a non-negative interger variable indicating how many times a column j shows up in the optimal solution.

In some embodiments, due to the nature of the objective function minimization in this problem, the optimal value of xⱼ does not exceed 1.

In several embodiments, the CP routing problem can then be formulated as follows:

$$\begin{matrix}min . & {\sum }_{j ∈ Ω} {c}_{j} {x}_{j}\end{matrix} \qquad ( 1 )$$

$$\begin{matrix}s . t . & {\sum }_{j ∈ Ω} {e}_{p j} {x}_{j} \geq 1 , ∀ p ∈ P\end{matrix} \qquad ( 2 )$$

$${x}_{j} ∈ {Z}_{+} , j ∈ Ω \qquad ( 3 )$$

In this formulation, j refers to the index of a candidate load in the set Ω. Z refers to the set of all non-negative integers. p refers to a purchase order in the input purchase order set [symbol] . The objective function defined by (1) aims to minimize the total cost metrics. Constraints (2) require that each purchase order has to be consolidated into a load. Constraints (3) define the decision variable types.

In a number of embodiments, CP routing can be determined without considering a CP capacity, as the coverage DCs are highly interrelated among different CPs. In several embodiments, a foremost concern or goal of CP routing can be to find as many feasible loads as possible. In some embodiments, each load constructed can include a possible set of feasible arrival dates so that the load selection can decide on an exact date of arrival for a load.

In a number of embodiments, the column generation process can start (e.g., begin) with relaxing the above model by converting the integral xⱼ variable into a continuous variable, as follows:

$$\begin{matrix}min . & {\sum }_{j ∈ Ω} {c}_{j} {x}_{j}\end{matrix} \qquad ( 4 )$$

$$\begin{matrix}s . t . & {\sum }_{j ∈ Ω} {e}_{pj} {x}_{j} \geq 1 , ∀ p ∈ P\end{matrix} \qquad ( 5 )$$

$${x}_{j} \geq 0 , j ∈ Ω \qquad ( 6 )$$

In some embodiments, starting with a subset of loads, denoted by Ω_{M}, as the initial columns, from which we get the restricted master problem (RMP), can be used without a full set of loads in which to start, as follows:

$$\begin{matrix}min . & {\sum }_{j ∈ {Ω}_{M}} {c}_{j} {x}_{j}\end{matrix} \qquad ( 7 )$$

$$\begin{matrix}s . t . & {\sum }_{j ∈ {Ω}_{M}} {e}_{pj} {x}_{j} \geq 1 , ∀ p ∈ P\end{matrix} \qquad ( 8 )$$

$${x}_{j} \geq 0 , j ∈ {Ω}_{M} \qquad ( 9 )$$

In several embodiments, let πₚ be the dual value associated with the constraint set (8), then the reduced cost of a potential new column can be j∈Ω/Ω_{M}

$${r}_{j} = {c}_{j} - {\sum }_{p ∈ P} {e}_{pj} {π}_{p} \qquad ( 10 )$$

In various embodiments, in this equation 10, cⱼ can refer to a typical cost of a load, and the second part can include the summation of the dual values of the purchase orders on the load.

In several embodiments, block 715 also can include deriving first respective cost metrics. In various embodiments, a cost metric can include one or more of a linehaul cost, a stop charge cost, a CP handling cost, a CP outbound cost, a transportation freight cost, and/or other suitable load route costs.

In some embodiments, block 715 further can include the multi-threaded column generation engine using linear programing to generate the respective candidate load routes.

In many embodiments, block 715 additionally can include determining respective times for each stop of the respective candidate load routes, wherein the respective times comprise (i) a pick-up time and (ii) a delivery time for each stop.

In several embodiments, block 715 also can include solving multiple subproblems for a lowest cost metric using multiple parallel routing engines. In various embodiments, each output of the multiple parallel routing engines can include a set of candidate load routes including a sequence of multiple pickup and delivery activities.

In some embodiments, each truck load or less than truck load of the candidate load routes can be based on a threshold fill rate. In some embodiments, consolidated loads (e.g., optimization outputs) can include a sequence of multiple pickup and delivery activities, where a full truck load (TL) or a less than full truckload (LTL) can be filled up to the threshold fill rate as part of the load route parameters.

In various embodiments, block 715 of generating respective candidate load routes can include consolidating each of the candidate load route into a route collecting queue.

In a number of embodiments, block 715 further can include selecting, using a picking solver algorithm, the respective candidate load routes from the route collecting queue.

In several embodiments, when a first cost metric for a first candidate load route of the respective candidate load routes exceeds a second cost metric of a second candidate route of the respective candidate load routes, method 700 optionally and additionally can include a block 720 of running one or more iterations of the candidate load route via a feedback loop back into the multi-threaded column generation engine to derive a subsequent cost metric. In some embodiments, using the feedback loop can be advantageous to ensure each shipment (e.g., load) can be picked up once and that one or more shipments can be combined in a respective candidate load route. In some embodiments, block 720 can be implemented as described below in connection with blocks 440, 450, 460 (FIG. 4).

In various embodiments, method 700 also can include a block 725 of selecting final load routes from the respective candidate load routes. In many embodiments, block 725 can be implemented as described above in connection with FIG. 6.

In some embodiments, block 725 further can include consolidating outputs of multiple sub-problems to minimize a final cost metric of remaining candidate load routes.

In several embodiments, block 725 additionally can include selecting final load routes from the respective candidate load routes where the final load routes do not exceed the final cost metric of the remaining candidate load routes.

In various embodiments, block 725 also can include selecting final load routes from the respective candidate load routes where each of the multiple sub-problems overlaps a portion of coverage with another one of the multiple sub-problems. In some embodiments, block 725 can be implemented as described below in connection with FIG. 5.

Returning to the drawings, in a number of embodiments, communication system 311 can at least partially perform block 401(FIG. 4) of receiving purchase orders as input data, block 480 (FIG. 4) of outputting an optimized candidate load route, and/or block 705 (FIG. 7) of receiving multiple purchase orders for delivery of items from vendors to distribution centers of a distribution network over a period of time.

In various embodiments, partitioning system 312 can at least partially perform block 430 (FIG. 4) of dividing, using a purchase order partition engine, the loads into subproblems and/or block 710 (FIG. 7) of generating partitions of the distribution network.

In some embodiments, generating system 313 can at least partially perform block 410 (FIG. 4) of managing an architectural data flow beginning at the input of purchase orders to the output of candidate load routes with a lowest cost metric from other candidate load routes, block 715 (FIG. 7) of generating respective candidate load routes for fulfilling the purchase orders for each of the partitions in parallel using a multi-threaded column generation engine, and/or block 720 (FIG. 7) of running one or more iterations of the candidate load route via a feedback loop back into the multi-threaded column generation engine to derive a subsequent cost metric.

In several embodiments, the column generation engine can employ an iterative approach to generate promising candidate loads. In many embodiments, the iterative approach can start with a set of intuitively created loads that can incur too much cost, the column generation engine can go through many iterations to create better loads to drive down the total cost metrics. In several embodiments, the iterative approach can consist of (i) a main solver that can derive the dual value (attractiveness) for each purchase order based on the set of loads that can be found in previous iterations, and (ii) a pricing solver that can utilize the dual values to create new loads that can reduce the total cost metrics. In various embodiments, these dual values can be updated in each iteration of the column generation process and can guide the algorithm to find better loads.

In several embodiments, selecting system 314 can at least partially perform block 470 (FIG. 4) of picking the optimized candidate load route from among the multiple candidate load routes with respective cost metrics and/or block 725 (FIG. 7) of selecting final load routes from the respective candidate load routes.

In various embodiments, calculating system 315 can at least partially perform block 440 (FIG. 4) of generating a candidate load route for a subproblem, block 450 (FIG. 4) of generating another candidate load route for another subproblem, block 460 (FIG. 4) of generating another candidate load route for another subproblem, and/or block 715 (FIG. 7) of generating respective candidate load routes for fulfilling the purchase orders for each of the partitions in parallel using a multi-threaded column generation engine.

In some embodiments, database system 316 can at least partially perform block 420 (FIG. 4) of storing multiple metrics and/or data points from multiple interactions in a data persistence layer.

In several embodiments, web server 320 can include a web page system 321. Web page system 321 can at least partially perform sending instructions to user computers (e.g., 350-351 (FIG. 3)) based on information received from communication system 311.

In a number of embodiments, building loads using a column generation engine can include an advantage of increased scalability. In some embodiments, scalability can begin with the following approach:
Enable routing and picking start at the same time by:
   Move the initial load generation from routing to picking.
   Revise the routing and picking I/O to enable periodical save/load.
   Change a picking and adapter processing flow to coordinate the changes.
Update the partition module to include different partition enhancements.
Scalability enhancement for multiple runs (regions) at the same time.

In various embodiments, scalability can be implemented by data and coding. In some embodiments, data can include:

a. Set the data model for all solver modules, if possible

b. Data transferring method design:
i. Ensure multiple instances read/write at the same time
ii. Database connection should be limited to a reasonable number

c. Data persistence and middleware is applied to facilitate the data transferring

d. Resource cost need to be considered in the design

In various embodiments, coding can include:

1. Separate the data layers to secure code changes in a limited size
i. Data transfer objects->common data models->module specific data models

2. Reduce the dependencies between modules as much as possible. Track task status when scaling out.

Various embodiments can include a system including one or more processors and one or more non-transitory computer-readable media storing computing instructions that when executed on the one or more processors, cause the one or more processors to perform certain acts. The acts can include receiving multiple purchase orders for delivery of items from vendors to distribution centers of a distribution network over a period of time. Each of the multiple purchase orders can specify a respective vendor of the vendors and a respective distribution center of the distribution centers. The acts also can include generating partitions of the distribution network. The acts further can include generating respective candidate load routes for fulfilling the purchase orders for each of the partitions in parallel using a multi-threaded column generation engine. The acts additionally can include selecting final load routes from the respective candidate load routes.

A number of embodiments can include a method being implemented via execution of computing instructions configured to run at one or more processors and stored at one or more non-transitory computer-readable media. The method can include receiving multiple purchase orders for delivery of items from vendors to distribution centers of a distribution network over a period of time. Each of the multiple purchase orders can specify a respective vendor of the vendors and a respective distribution center of the distribution centers. The method also can include generating partitions of the distribution network. The method further can include generating respective candidate load routes for fulfilling the purchase orders for each of the partitions in parallel using a multi-threaded column generation engine. The method additionally can include selecting final load routes from the respective candidate load routes.

Although automatically generating respective candidate load routes for fulfilling purchase orders using a multi-threaded column generation engine has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 4 and 6-7 may include different procedures, processes, and/or activities and be performed by many different modules, in many different orders, and/or one or more of the procedures, processes, or activities of FIGS. 4 and 6-7 may include one or more of the procedures, processes, or activities of another different one of FIGS. 4 and 6-7. As another example, as shown in FIG. 3, the systems within system 300, column generation engine, and/or web server 320, such as communication system 311, partitioning system 312, generating system 313, selecting system 314, calculating system 315, learning system 316, and/or web page system 321, can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving multiple purchase orders for delivery of items from vendors to distribution centers of a distribution network over a period of time, wherein each of the multiple purchase orders specifies a respective vendor of the vendors and a respective distribution center of the distribution centers;
generating partitions of the distribution network;
generating respective candidate load routes for fulfilling the purchase orders for each of the partitions in parallel using a multi-threaded column generation engine; and
selecting final load routes from the respective candidate load routes.

2. The system of claim 1, wherein generating the respective candidate load routes further comprises:
deriving first respective cost metrics.

3. The system of claim 1, wherein the multi-threaded column generation engine uses linear programing to generate the respective candidate load routes.

4. The system of claim 1, wherein the computing instructions, when executed on the one or more processors, further cause the one or more processors to perform:
when a first cost metric for a first candidate load route of the respective candidate load routes exceeds a second cost metric of a second candidate route of the respective candidate load routes, running one or more iterations of the candidate load route via a feedback loop back into the multi-threaded column generation engine to derive a subsequent cost metric.

5. The system of claim 1, wherein selecting the final load routes from the respective candidate load routes comprises:
consolidating outputs of multiple sub-problems to minimize a final cost metric of remaining candidate load routes.

6. The system of claim 5, wherein:
the final load routes do not exceed the final cost metric of the remaining candidate load routes.

7. The system of claim 5, wherein:
each of the multiple sub-problems overlaps a portion of coverage with another one of the multiple sub-problems.

8. The system of claim 1, wherein generating partitions of the distribution network comprises:
dividing the distribution network into the partitions based on at least one of (i) the distribution centers of the distribution network or (ii) center points of the distribution network.

9. The system of claim 1, wherein generating the respective candidate load routes comprises:
determining respective times for each stop of the respective candidate load routes, wherein the respective times comprise (i) a pick-up time and (ii) a delivery time for the each stop.

10. The system of claim 1, wherein generating the respective candidate load routes comprises:
solving multiple subproblems for a lowest cost metric using multiple parallel routing engines, wherein each output of the multiple parallel routing engines comprises a set of candidate load routes including a sequence of multiple pickup and delivery activities, wherein each truck load or less than truck load of the candidate load routes is based on a threshold fill rate;
consolidating each of the candidate load route into a route collecting queue; and
selecting, using a picking solver algorithm, the respective candidate load routes from the route collecting queue.

11. A method being implemented via execution of computing instructions configured to run on one or more processors and stored at one or more non-transitory computer-readable media, the method comprising:
receiving multiple purchase orders for delivery of items from vendors to distribution centers of a distribution network over a period of time, wherein each of the multiple purchase orders specifies a respective vendor of the vendors and a respective distribution center of the distribution centers;
generating partitions of the distribution network;
generating respective candidate load routes for fulfilling the purchase orders for each of the partitions in parallel using a multi-threaded column generation engine; and
selecting final load routes from the respective candidate load routes.

12. The method of claim 11, wherein generating the respective candidate load routes further comprises:
deriving first respective cost metrics.

13. The method of claim 11, wherein the multi-threaded column generation engine uses linear programing to generate the respective candidate load routes.

14. The method of claim 11, further comprising:
when a first cost metric for a first candidate load route of the respective candidate load routes exceeds a second cost metric of a second candidate route of the respective candidate load routes, running one or more iterations of the candidate load route via a feedback loop back into the multi-threaded column generation engine to derive a subsequent cost metric.

15. The method of claim 11, wherein selecting the final load routes from the respective candidate load routes comprises:
consolidating outputs of multiple sub-problems to minimize a final cost metric of remaining candidate load routes.

16. The method of claim 15, wherein:
the final load routes do not exceed the final cost metric of the remaining candidate load routes.

17. The method of claim 15, wherein:
each of the multiple sub-problems overlaps a portion of coverage with another one of the multiple sub-problems.

18. The method of claim 11, wherein generating partitions of the distribution network comprises:
dividing the distribution network into the partitions based on at least one of (i) the distribution centers of the distribution network or (ii) center points of the distribution network.

19. The method of claim 11, wherein generating the respective candidate load routes comprises:
determining respective times for each stop of the respective candidate load routes, wherein the respective times comprise (i) a pick-up time and (ii) a delivery time for the each stop.

20. The method of claim 11, wherein generating the respective candidate load routes comprises:
solving multiple subproblems for a lowest cost metric using multiple parallel routing engines, wherein each output of the multiple parallel routing engines comprises a set of candidate load routes including a sequence of multiple pickup and delivery activities, wherein each truck load or less than truck load of the candidate load routes is based on a threshold fill rate;
consolidating each of the candidate load route into a route collecting queue; and
selecting, using a picking solver algorithm, the respective candidate load routes from the route collecting queue.
